(19) United States
(12) Patent Application Publication
(10) Pub. No.: US 2017/0231846 A1
(43) Pub. Date: Aug. 17, 2017

(54) DEVICE FOR INSERTING SUPPORT BETWEEN SURFACES

(71) Applicant: Stephen P. Farrington, Stockbridge, VT (US)

(72) Inventor: Stephen P. Farrington, Stockbridge, VT (US)

(73) Assignee: Transcend Engineering and Technology, LLC, Bethel, VT (US)

(21) Appl. No.: 15/369,322

(22) Filed: Dec. 5, 2016

Related U.S. Application Data
(60) Provisional application No. 62/262,751, filed on Dec. 3, 2015.

(51) Int. Cl. A61G 7/10

(52) U.S. Cl. CPC A61G 7/1021; A61G 7/1019; A61G 7/1011; A61G 7/1057; A61G 2200/325

(57) ABSTRACT

A device for inserting a support beneath an object is provided that includes an eversible tubular membrane with a closed end and an open end with the open end sealably connected to a container enclosing a pressurized fluid, wherein the closed end is connected such that it can be retracted under tension through the inside of the tube formed by the radially outward facing aspect of the membrane, and wherein with pressure and/or tension changes the membrane can be eversibly extended and retracted between two surfaces. In addition, the membrane may be co-everted with a sling or draw sheet such that the sling or draw sheet can be inserted between two surfaces along with the membrane. Further, multiple eversible membranes may be inserted between two surfaces or beneath an object or a patient in accordance with the disclosed invention.

### RELATED APPLICATION DATA

This application claims priority to U.S. Provisional Application No. 62/262,751 filed Dec. 3, 2015.

### FIELD OF THE INVENTION

The present invention generally relates to methods and apparatuses for inserting supports or appendages between two surfaces.

### BACKGROUND

Healthcare workers experience more musculoskeletal disorders than workers in construction, mining, manufacturing, and wholesale and retail trade. These injuries are largely due to repeated manual patient handling activities, often involving heavy lifting when transferring and repositioning patients, working in extremely awkward postures, and pushing and pulling heavy objects. The risk is magnified by the increasing weight of patients due to the U.S. obesity epidemic and the rapidly increasing number of older people who require assistance with the activities of daily living. Nurses are required to lift or support morbidly obese patients as many as 15 to 20 times a day, and 12% of registered nurses who quit the field do so because of back pain due to patient handling.

While myriad devices, such as slings, hoists, transfer boards, etc., abound for bearing the weight of infirm patients, to the present inventor's knowledge no practical solution exists for inserting the patient bearing component of a lift or transfer device between the patient to be moved and the surface on which they are already resting. To the present inventor's knowledge, no prior art references describe a device or method for inserting a patient-bearing element such as a sling, draw sheet, patient transfer sheet, inflatable pad, or straps beneath a patient by movement in a direction transverse to the patient's longitudinal orientation without rolling the patient from side to side or inducing significant abrasive force in the direction of insertion.

In addition, moving patients from the ground onto a stretcher, such as may be required in emergency response settings, may pose a risk of injury for both the patient and the healthcare workers. In other settings as well, lifting and moving objects can be more difficult when the objects rest directly on the ground with no other supporting elements underneath to facilitate leverage and safe handling.

What is needed, therefore, is a system, method and apparatus that can safely and effectively insert a support element between two surfaces to facilitate lifting an object.

### SUMMARY OF THE DISCLOSURE

A system for inserting support between two surfaces or beneath an object is provided having a plurality of casings each having a mouth and a spool, wherein each of the plurality of casings is suitable for containing a pressurized fluid, a pressure device fluidly coupled to the plurality of casings, wherein the pressure device pressurizes a fluid and a plurality of membranes each having a closed end and an open end, wherein the open end of each of the plurality of membranes is sealably attached to a corresponding respective mouth of one of the plurality of casings, and wherein the closed end of each of the plurality of membranes is connected to a corresponding respective spool of one of the plurality of casings, and wherein, when the pressure device pressurizes the fluid, the plurality of membranes is moved away from the corresponding casing resulting in each membrane being everted between two unconnected surfaces.

The disclosed invention further provides a frame with an opening, a proximal side, and a distal side, wherein the proximal side supports the plurality of casings, and the plurality of membranes, after everting, can be coupled to the distal side of the frame. The present invention further provides a device for inserting a support between two surfaces with a substantially rigid casing suitable for containing a pressurized fluid and having a mouth and a seal, a pressure device fluidly coupled to the casing, wherein the pressure device pressurizes a fluid contained within the casing and a substantially tubular membrane having a closed end and an open end, wherein the open end is sealably attached to the mouth of the casing and the closed end is attached to an axially movable rigid support member, wherein when the pressure device pressurizes the fluid such that the closed end of the membrane is moved away from the canister resulting in the membrane being everted between two discontinuous surfaces such that the rigid support is inserted between the two surfaces.

The present invention further provides a device for inserting a support between two surfaces including a casing suitable for containing a pressurized fluid and having a mouth and a pressure device fluidly coupled to the casing, wherein the pressure device pressurizes a fluid contained within the casing and a substantially tubular membrane having a closed end and an open end, wherein the open end is sealably attached to the mouth of the casing and wherein when the pressure device pressurizes the fluid such that the closed end of the membrane is moved away from the casing resulting in the membrane being everted between two surfaces,

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1A is an exemplary embodiment of the present invention.

FIG. 1B is a cutaway of FIG. 1A.

FIG. 1C is a cutaway of the embodiment of FIG. 1A when partially extended in accordance with the present invention.

FIG. 2 is a cross sectional depiction of an embodiment of the present invention.

FIG. 3A is another exemplary embodiment of the present invention.

FIG. 3B depicts the embodiment of FIG. 3A partially extended.

FIG. 3C depicts the embodiment of FIG. 3A further extended.

FIG. 4A is another exemplary aspect of the present invention.

FIG. 4B depicts the embodiment of FIG. 4A extended,

FIG. 5 is another exemplary aspect of the present invention.

FIG. 6A is another exemplary aspect of the present invention.

FIG. 6B depicts the embodiment of FIG. 6A at another stage.

FIG. 6C depicts the embodiment of FIG. 6A at another stage.

FIG. 6D depicts the embodiment of FIG. 6A at another stage.

FIG. 6E is another view of the embodiment of FIG. 6A.

FIG. 7A shows a partial view of another feature of the present invention.

FIG. 7B is a partial view of the feature of FIG. 7A at another stage.

FIG. 8 is another exemplary aspect of the present invention.

### DESCRIPTION OF THE DISCLOSURE

The present invention can facilitate the safe handling of an object by inserting supportive elements under the object, even though the object is resting on a surface, without exerting significant abrasive forces against the object. Devices disclosed herein can be used in many fields of application to insert material between two contacting or closely spaced surfaces, or spread two surfaces. In addition, devices disclosed may be used to handle and manipulate objects that the devices are also capable of gripping,

In one embodiment, a device made in accordance with the present disclosure may comprise a soft robotic device that performs a method of gently inserting one or more support elements beneath an object while minimizing danger to the object, such as inserting various types of patient-bearing elements beneath a resting patient without causing unacceptable discomfort or risk of harm to the patient. Aspects of the present disclosure fill a capability gap identified by clinicians as the biggest challenge left unaddressed by other techniques and devices intended to facilitate safe patient handling. Aspects of the present disclosure can also be used to insert support or other materials beneath a broad variety of bodies including animals, boats, shipping containers and other objects.

The described devices can act alone or can complement and enhance other existing devices for moving, repositioning, and transferring patients that are effective only after one or more patient supporting elements, such as slings, straps, draw sheets, or transfer pads have been emplaced beneath the patient using the described devices. The described devices can be implemented in any of several different embodiment. One such embodiment is a handheld device for inserting a draw sheet, patient transfer sheet, inflatable pad, or sling beneath an individual. Another embodiment is a machine for supporting, lifting, and moving an immobile individual. Other embodiments in other contexts, as described elsewhere herein, are also useful.

The devices described herein complement related devices by providing a means to get needed support elements, such as a simple draw sheet, a glide pad, a sling, or multiple straps of nylon webbing, under a patient,

In some aspects of the present disclosure, the devices disclosed herein can use dynamically controlled morphological transformation to subduct at least one pliable extensible appendage formed by an eversible tubular sheet (e.g., membrane) between two objects. The at least one appendage may comprise a sealed tubular membrane containing a compressible or incompressible fluid (including liquids and gases) or other suitable material (e.g., gel); the appendage may have a distal end which is closed and a proximal end which is sealed to, e.g., a rigid housing facilitating containment of the fluid in a radial and an axial direction. The distal end of the membrane may be closed by nature of the continuity of the membrane material, by sealing to itself, or by sealing to another component that is able to move with the distal end relative to the proximal end (e.g., a plug or stopper).

The membrane can comprise an elastic or inelastic material depending on the specific embodiment and application, and may have one (e.g., external) surface facing away from the contained fluid and one (e.g., internal) surface facing the contained fluid. In some embodiments, the membrane may be partially elastic and partially inelastic and may vary in elasticity along the length or axial direction of the membrane or the appendage formed by the membrane. In these and other embodiments, the flexibility of the membrane may also vary over its surface or as a function of the direction of flexure. For instance, stiffer materials may be incorporated into the membrane continuously or as ribs or battens oriented substantially transverse to its axial direction to form an appendage that retains a non-circular cross-section in its radial direction.

Within the filled interior of the tubular membrane, a flexible or rigid traveling member may be disposed, which may have a distal end abutting or connected to the fluid-facing inner surface of the closed distal end of the membrane and a proximal end attached to a means of actuating motion (e.g., an electromagnetic actuator or a piston) of the traveling member relative to the proximal end of the membrane in a direction that is axial to the appendage formed by the membrane.

Movement of the internal traveling member and optionally attached distal end of the membrane through and then distally away from the proximal end of the membrane (e.g., towards a patient) causes eversion of the membrane resulting in moving division of the non-fluid facing surface of the membrane into at least two orientations, one orientation facing radially inward and one orientation facing radially outward, such that the outward facing portion of the surface emerges from within the appendage, such portion of the surface having been previously inward facing.

Travel of the internal traveling member optionally affixed to the distal end of the membrane can be controlled by, for example, attaching a flexible traveling member to a motorized winch or spool, which can also be moved using a pneumatically or hydraulically actuated piston.

The appendage can thus be elongated and shortened by controlled interaction of the fluid pressure within the membrane and/or actuation of the traveling internal member.

The morphological transformation of the appendage induced by the eversion of the fluid filled membrane thus achieved enables elongation and shortening of the appendage without incurring any significant axially directed motion of the radially outward facing surface of the membrane (e.g., the appendage can be inserted under or behind a patient without requiring that the patient be moved and without risking any abrasions or other safety issues for the patient). This enables elongation of the appendage between the surfaces of two external entities (e.g., a patient and a bed) without rubbing against these surfaces such that any frictional forces produced are minimized in order to protect the external entities (e.g., a patient from discomfort or injury, a bedsheet from being ripped, or otherwise, as appropriate for particular implementations). Alternative embodiments can also be used to manipulate radioactive or potentially radioactive materials (e.g., radioactive waste) with minimal risk of shuffling the materials in such a way that a criticality could occur, as an appendage made in accordance with the present disclosure can be inserted beneath/between materials while minimizing any disturbances to the materials.

Since this morphological transformation occurs in a manner that induces no, or at least very minimal, relative lateral motion between contacting surfaces of the device or objects being manipulated, devices made in accordance with the present disclosure can gently extend a soft conduit beneath the patient or other object to be lifted, through or adjacent to which can be guided other support elements. Alternatively, additional eversible layers of materials such as glide sheets, draw sheets, and/or a fabric sling can be wrapped around and then everted within the everting tubular membrane appendages, e.g., such that in some embodiments they undergo the same everting morphological transformation and thus are also gently subducted beneath the patient while causing minimal displacement and without inducing lateral or transverse friction (which can be further minimized by properly modulating the pressure of the internal fluid/material within the appendage and/or the speed of eversion) during insertion.

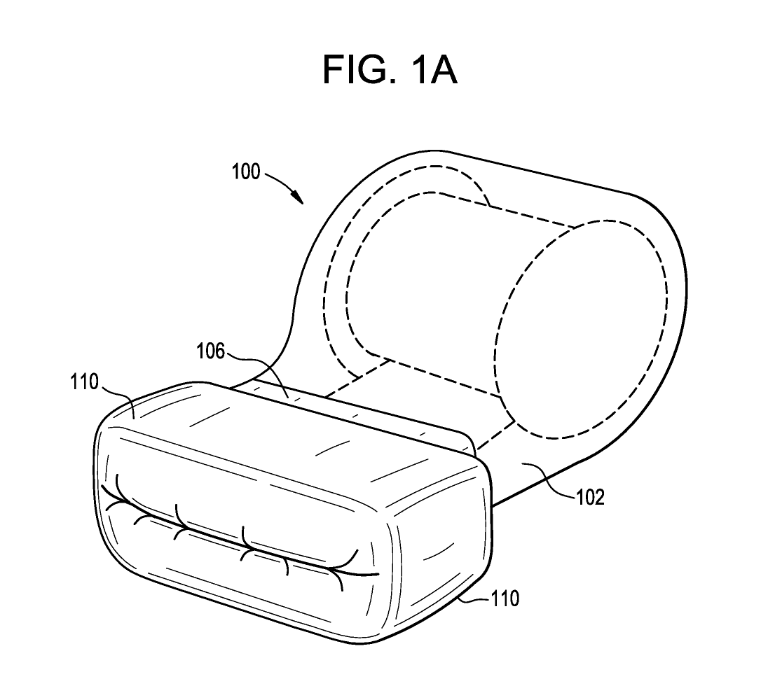

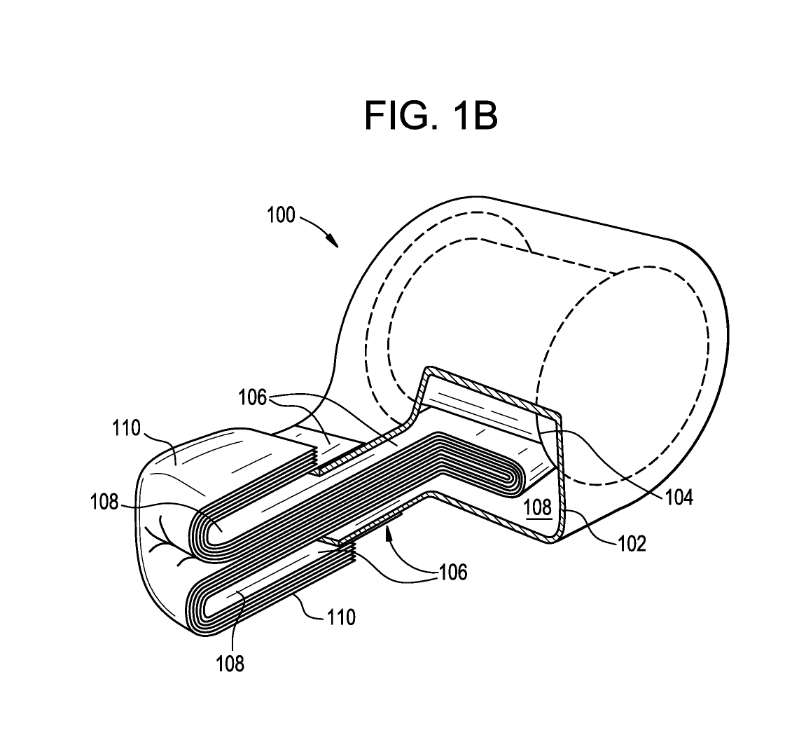

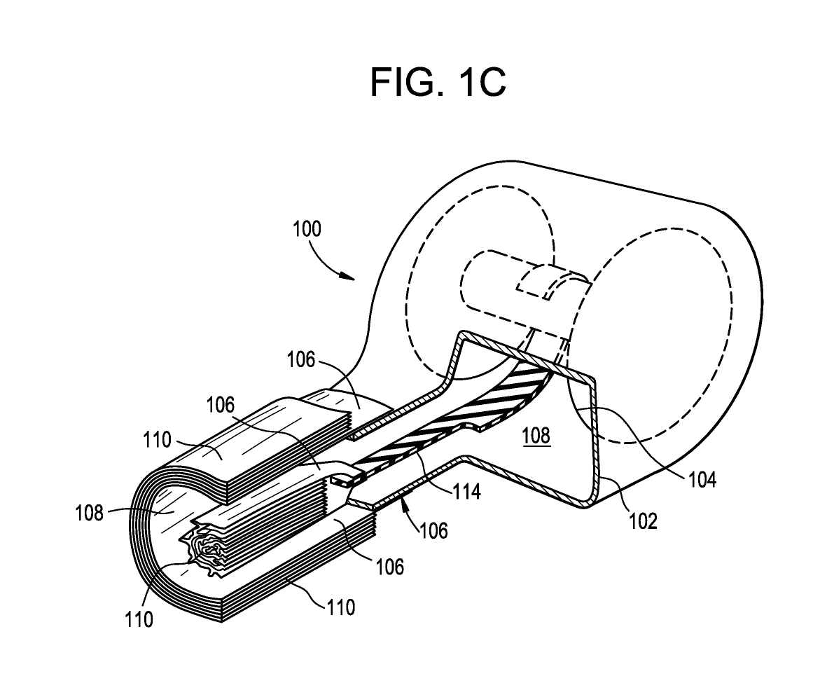

FIG. 1A is a device 100 that can insert a membrane under an object in accordance with an embodiment of the present invention. Depending on the intended application, the device 100 may be handheld or other size. Device 100 includes a sealed canister 102 that houses fluid under pressure. Although not shown in FIG. 1A, device 100 may also include input and release valves, sources for pressurized fluid, and user controls for activating the extension and retraction mechanisms.

Devices like that shown in FIG. 1A can be used in several ways to deploy support under a patient. In the simplest embodiment, a single handheld device includes an appendage that can be wrapped or “coated” in additional eversible layers of materials such as a rolled up glide sheet, draw sheet, or fabric sling, such that these accompanying materials also evert to gently subduct beneath the patient for subsequent use in rolling, lateral transfer, or lifting with a hoist (fabric sling). FIG. 1B and FIG. 1C are cutaway views of the example handheld embodiment shown in FIG. 1A. The sealed canister 102 may include a mechanism for retracting and dispensing the appendage. As shown in FIGS. 1B and 1C, a spool 104 and the appendage is an eversible tubular membrane 106, the eversible tubular membrane having an open end sealed to a mouth of the canister 102 and a closed end and capable of containing layers of a patient-bearing element 110, such as, but not limited to, a glide pad, a draw sheet, or a fabric sling, folded or wrapped upon itself such as to occupy a compact space, and a tether 114 having one end attached to the closed end of the eversible tubular membrane 106 and another end attached to the spool 104, such that the tether 114 and eversible tubular membrane 106 containing the patient-bearing element 110 can be wound upon the spool 104 and contained mostly within the canister 102 as depicted in FIG. 1B. Fluid under pressure expands and contracts within space 108 that is defined by canister 102 and an inner surface of membrane 106 when sealed to the mouth of canister 102. Further included are a mechanism (not shown) of turning the spool 104 bi-directionally (or other mechanism for retracting and releasing the tether 114), a mechanism (not shown) of controlling the turning of the spool 104, and a mechanism (not shown) of increasing and decreasing the pressure inside the canister 102. The mechanism for turning spool 104 may be an electric motor or other suitable mechanism. The mechanism for controlling the turning of spool 104 may be user-operated push buttons which provide input to a motor control circuit or it may be other suitable mechanism. The mechanism for increasing and decreasing pressure in canister 102 may be solenoid actuated valves which control the release of gas from a pressurized gas source such as one or more disposable CO₂ cartridges, bottled gas, a portable air compressor, centrally supplied hospital instrument air, or other suitable source. In this embodiment, eversible tubular membrane 106 and patient-bearing element 110 wrapped therein are extruded from canister 102 by the force of pressure acting from within canister 102 on a frontal face area of eversible membrane 106 where the eversible membrane 106 protrudes from the mouth of canister 102. The rate of advance of the extending membrane 106 is controlled by tension acting by spool 104 on membrane 106 through the attached tether 114 and in opposition to the direction of the pressure-generated force pushing the face of membrane 106 outward. When the eversible membrane 106 is not extended very far it is mostly within canister 102 and wrapped around the spool 104 such that the spool tension acts directly on membrane 106. As eversible membrane 106 extends farther, the eversible membrane 106, along with co-wrapped patient-bearing element 110, unwinds from spool 104 and the closed end of membrane 106 eventually comes off spool 104 but is still held in tension by tether 114 as shown in FIG. 1C.

In a preferred embodiment in the area of patient handling, applying between 20 and 40 psi of pressure inside the everting membrane causes the membrane to extend under the patient in about 3-8 seconds, which corresponds with the leading edge of the membrane progressing at a speed of about 5 to 12 inches per second.

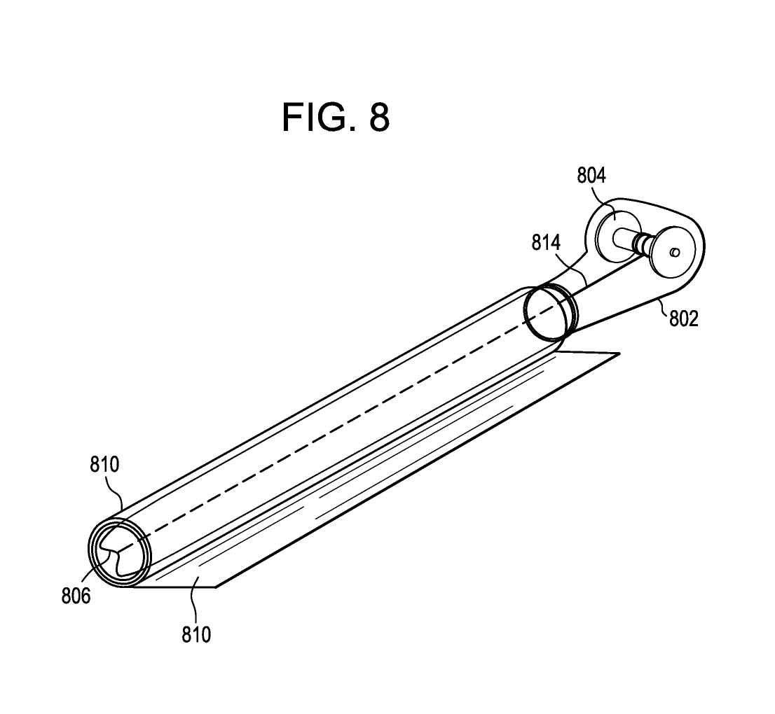

In operation, a patient-bearing element 110 can be preloaded onto eversible membrane 106 by first fully extending membrane 106 out of canister 102 to form a tube of membrane 106, with an outer portion exposed to atmosphere and an inner portion exposed to and containing fluid pressure in space 108 from canister 102. Patient-bearing element 110 can then be wrapped around the tube formed by the extended membrane, forming a sleeve around the outer portion of the membrane. FIG. 8 for example shows a fully extended membrane 806 wrapped in patient-bearing element 810, in which membrane 806 is attached to a spool 804 in a canister 802 by a tether 814. The end of patient-bearing element 810 closest to the closed end of the extended membrane 806 can then be turned inward to contact the closed end of the extended membrane 806 and the pressure in the tube and canister can then be lessened so the tension of spool 104/804 causes tether 114/814 to pull the closed end of membrane 106/806 back toward spool 104/804. As this occurs, the end of patient-bearing element 110/810 in contact with the closed end of membrane 106/806 will become enveloped in the receding edge of the tube, thus becoming everted along with membrane 106/806 and eventually wound onto spool 104/804 in canister 102/802, pre-loaded and ready to be everted and form an appendage with increased pressured and/or decreased tension on spool 104/804. Devices of the present invention can in this way be preloaded with a sling, draw sheet, or similar patient-bearing element for immediate use and can be stored in this condition in hospitals or ambulances.

In another method of preloading the device with a sling or similar patient-bearing element, the patient-bearing element need not be initially wrapped around the extended membrane, but can be rolled, folded, or otherwise formed into a long narrow shape and disposed end-to-end against the closed end of the extended membrane and in axial alignment with the extended membrane, such that as the pressure in the tube and canister are lessened and the tension of the spool causes the tether to pull the closed end of the membrane back toward the spool, the end of the patient-bearing element in contact with the closed end of the membrane becomes enveloped in the receding edge of the tube, thus being drawn into and radially enclosed by the inward facing aspect of the membrane and eventually wound onto the spool. The end of the patient-bearing element initially disposed most distant from the device may then protrude slightly from the preloaded device and this end may be folded back and held in place with the canister as the appendage is extended beneath a patient such that the remainder of the patient-bearing element emerges from within the advancing membrane into a position beneath the patient and adjacent to the extended appendage.

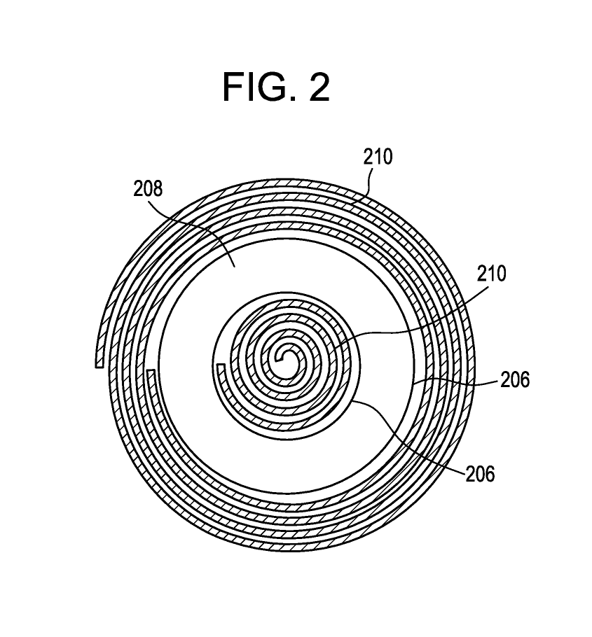

FIG. 2 depicts an illustrative cross sectional view of an appendage in the process of being everted along with a membrane. Space 208 contains pressurized fluid that exerts pressure on eversible membrane 206. The radially outward portion of membrane 206 in FIG. 2 along with the radially outward portion of sling 210 forms the outside of a tube that is extending away from a device (and for some applications between two surfaces). The radially inward portions of eversible membrane 206 and sling 210 in FIG. 2 have been unwound from a spool but have not yet been expanded into the outside of the tube at the leading edge of the appendage (which may be expanding or contracting).

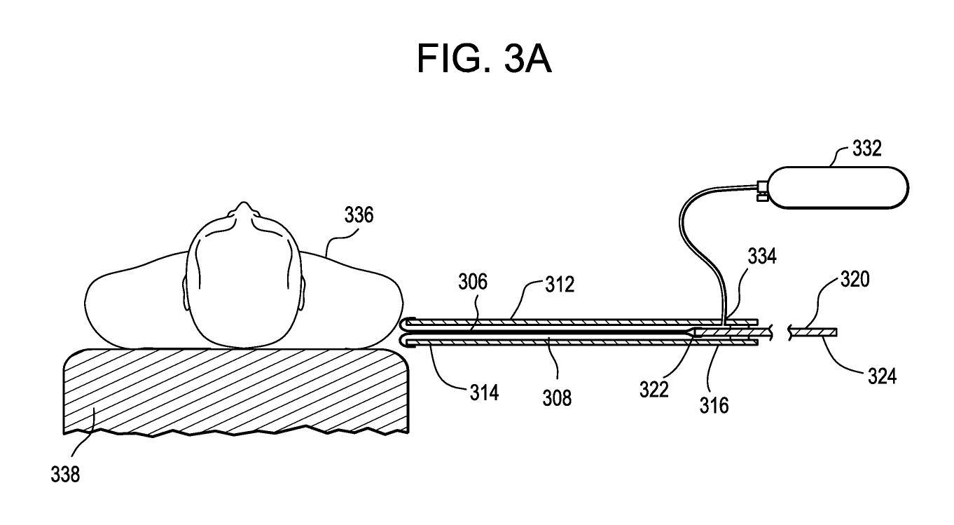

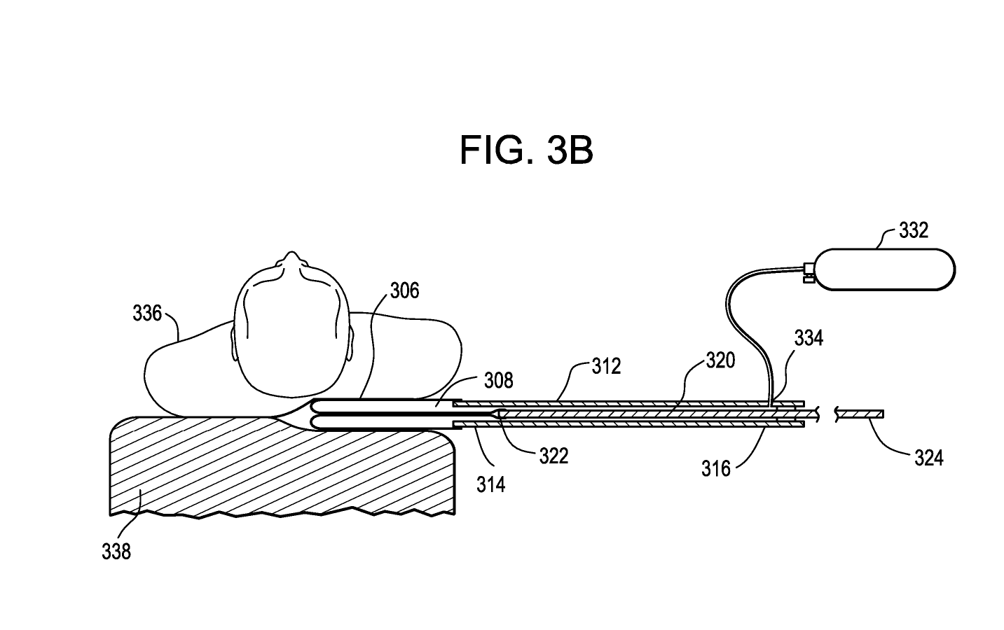

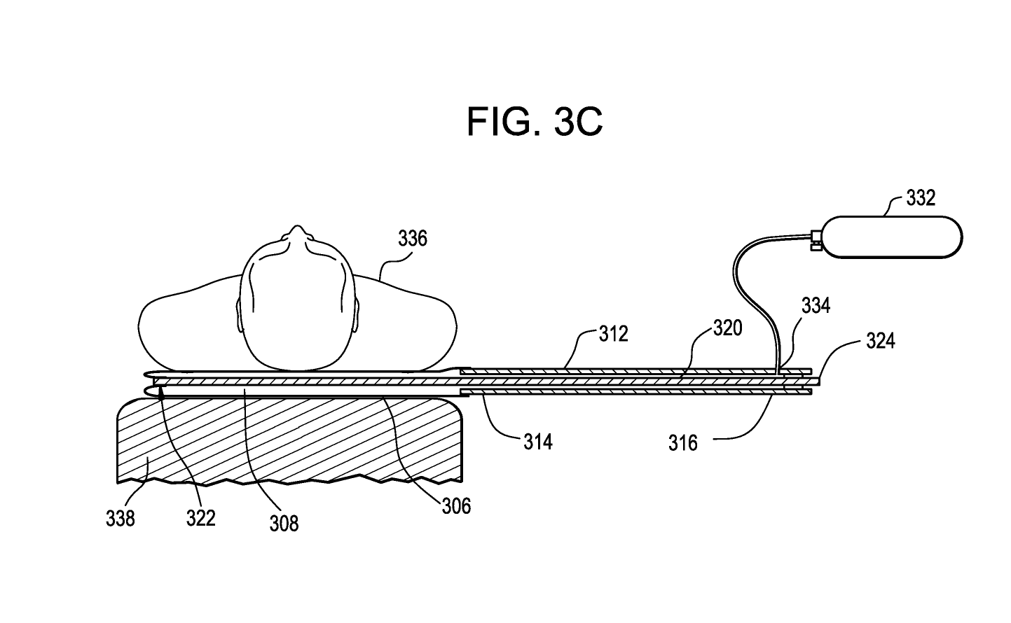

Depending on the specific embodiment of the device, the internal tension element previously described may be a flexible element such as a Keviar® strip, cord, or nylon strap, a rigid support member such as carbon fiber composite tube or other rigid or semi-rigid member, or a combination thereof, optionally including one or more telescoping members. In the case of a rigid or semi-rigid element, the fluid-filled eversible membrane cushions the patient or object from the encapsulated element. FIG. 3A-3C shows a schematic of this concept in three stages of insertion beneath a patient 336.

The apparatus of FIG. 3A includes a pressure source 332 connected to a hollow member 312 through a duct 334. A solid member 320 is free to move axially in relation to the hollow member 312 permitting the shape of eversible membrane 306 to assume any proportion of states from fully non-everted to fully everted. The volume of pressurized fluid in an annular space 308 can be adjusted through the duct 334 by the controlled pressure source 332 to adjust for the change in volume of the annular space 308 that occurs commensurate with axial movement of the solid member 320.

In FIG. 3A eversible membrane 306 is shown in a fully non-everted state commensurate with solid member 320 extended minimally into hollow member 312 such that a distal end 322 of solid member 320 is positioned just inside a proximal end 316 of hollow member 312, as would be the state of the apparatus prior to insertion beneath the patient 336.

In FIG. 3B eversible membrane 306 is shown in a partially everted and partially non-everted state commensurate with solid member 320, which is connected to an end of membrane 306 that is opposite an end of membrane 306 that is sealably connected to hollow member 312, extended partially into the hollow member 312 such that distal end 322 of solid member 320 is positioned near distal end 314 of hollow member 312, as would be the state of the device during insertion beneath the patient 336.

In FIG. 3C eversible membrane 306 is shown in a fully everted state commensurate with solid member 320 extended fully through hollow member 312 such that distal end 322 of solid member 320 extends beyond distal end 314 of the hollow member 312 and a proximal end 324 of the solid member 320 positioned just outside a proximal end 316 of hollow member 312, as would be the state of the device when it has been fully inserted beneath the patient 336 on bed 338.

In this manner, a support or a plurality of supports may be inserted beneath an object such that the object may be moved or lifted by a force applied from the side (of the object) from which the supports were inserted.

In some embodiments, pressurized fluid (although other optionally non-fluidic materials can be used, as discussed above) will maintain inflation of the membrane and adjust dynamically to control extension and pressure on the subject. As an example of the loads transferred and resulting excess membrane pressures, twenty-five appendages, 3 cm (1.2 in) in diameter and 6 cm (2.4 in) apart, lifting a 136-kg (300-Ib) subject would support an average load of 5.5 kg (12 lb) each and have an average excess fluid pressure of 4.5 kPa (0.65 psi).

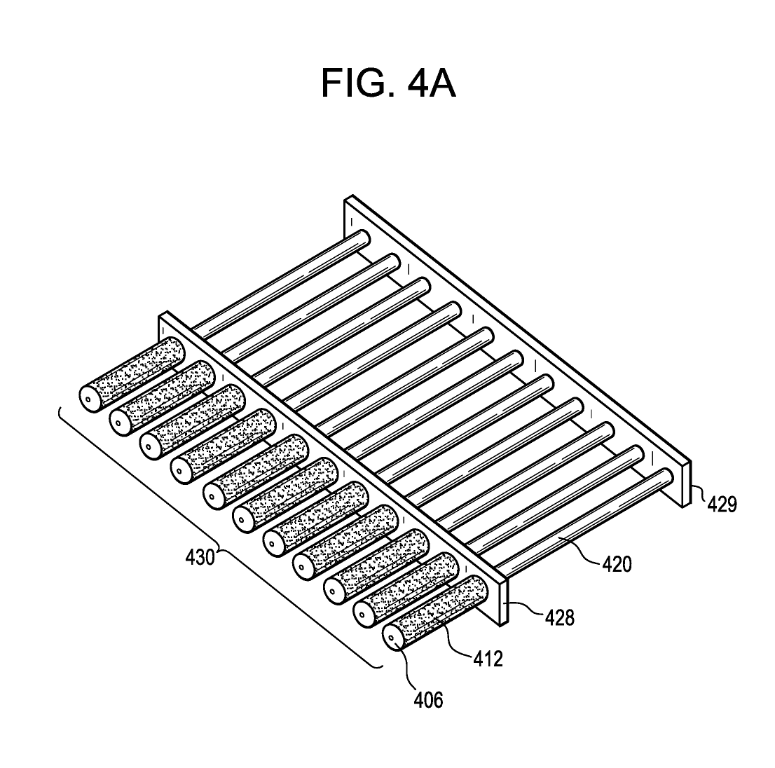

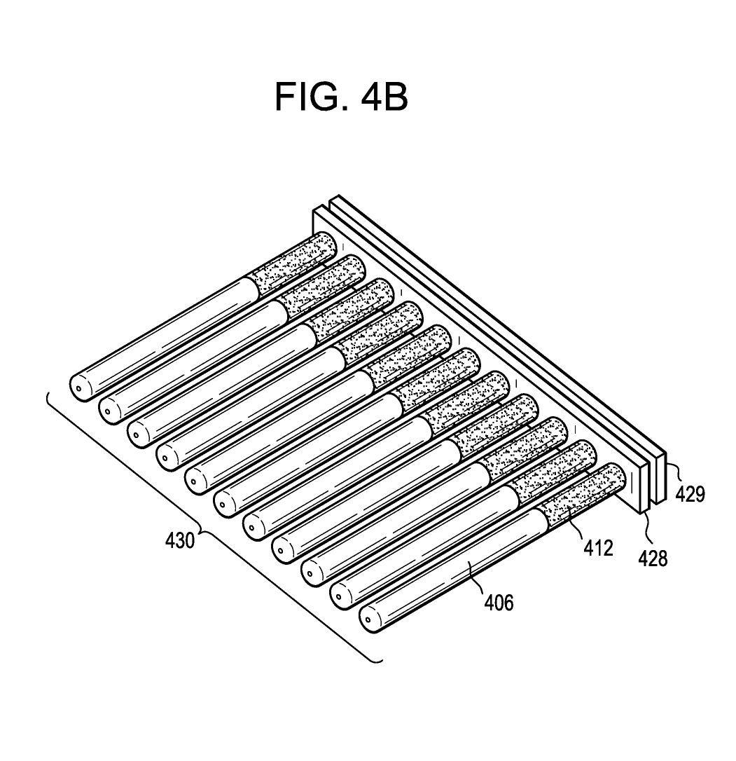

FIGS. 4A-4B show an embodiment in which multiple appendages 430 may be simultaneously inserted beneath an object. In FIG. 4A, each appendage includes an eversible membrane 406 within a hollow member 412 and connected to a support 420. Each hollow member is attached to a proximal member 428 and each support 420 is attached to a distal member 429. A force exerted against distal member 429 will cause all the appendages to evert and be inserted beneath an object simultaneously, thereby reducing the load for each appendage compared to insertion individually.

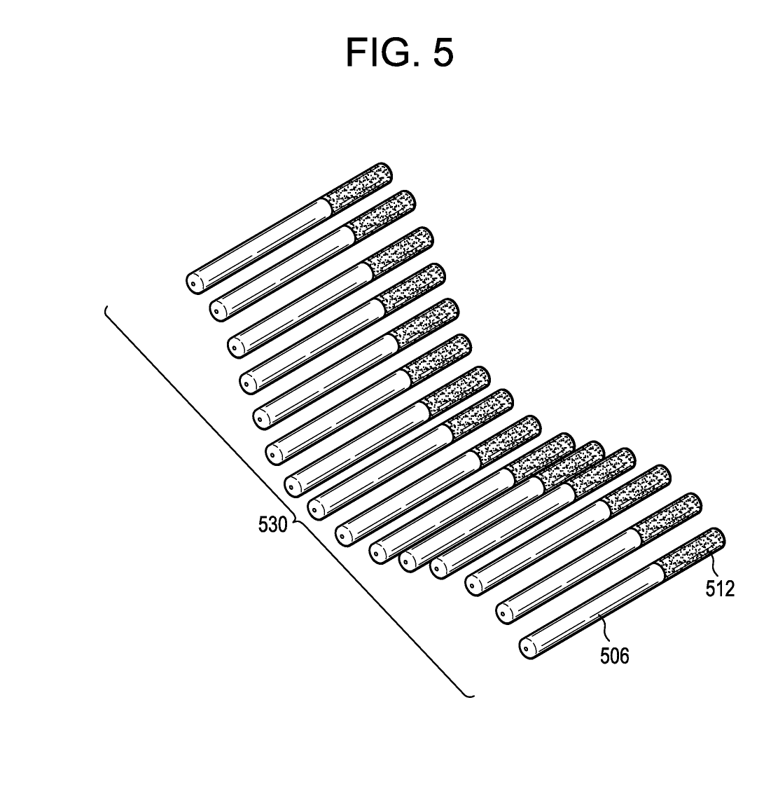

FIG. 5 depicts an example of a shape a device made in accordance with the present disclosure is capable of assuming when a set of individual appendages 530 are designed and configured to move translationally, e.g., by being manually operated or attached to hardware that enables such movement. Such positioning of the appendages could occur before insertion beneath an object (to conform to the shape of the object) or after insertion under the object (to place the object in a new configuration, or for comfort in the case of a patient). For each appendage, an eversible membrane 506 would evert out from a hollow member 512 and form a conduit beneath the object for simultaneous or subsequent insertion of a rigid support member therein.

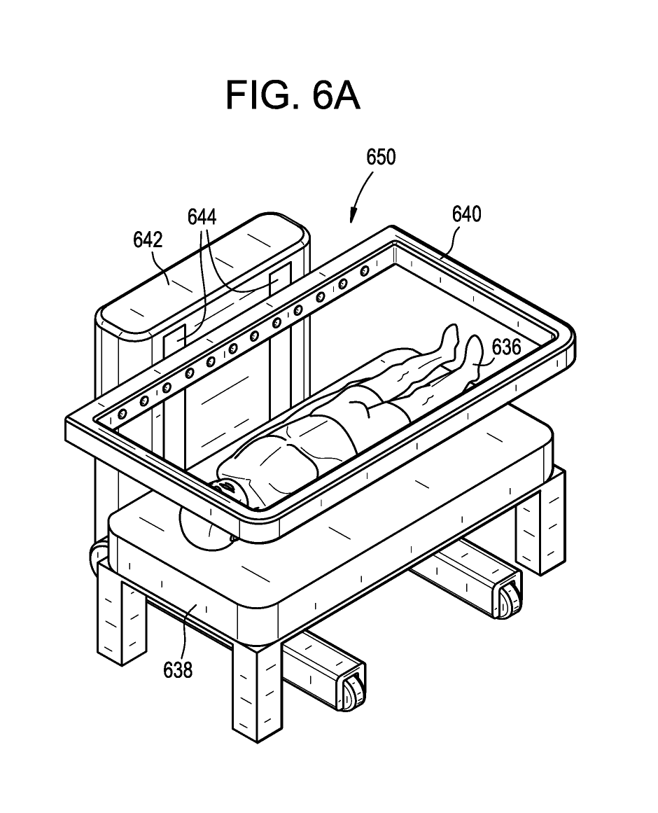

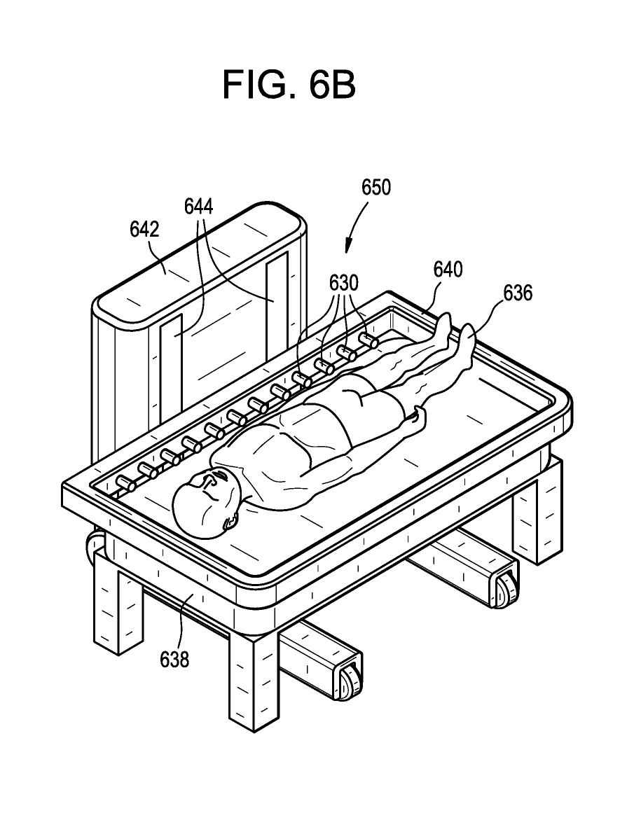

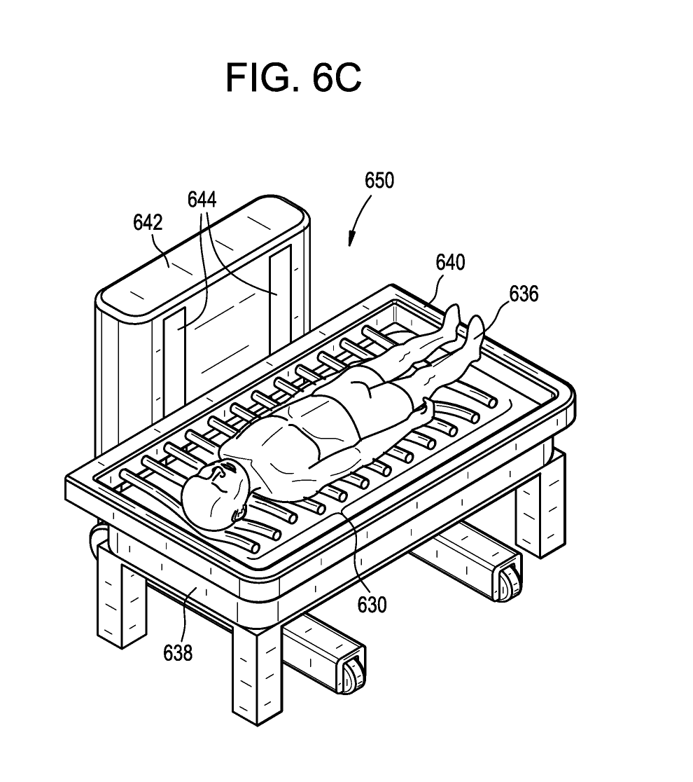

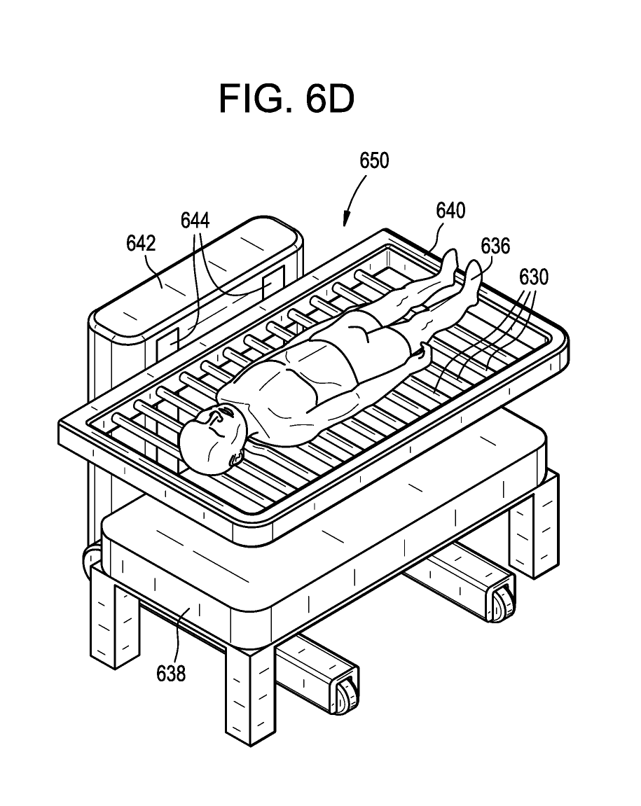

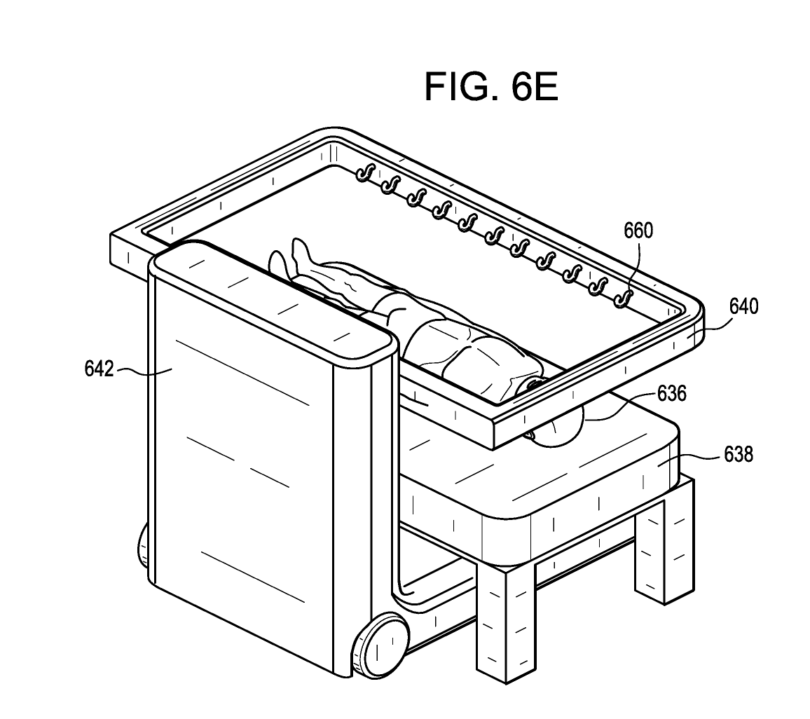

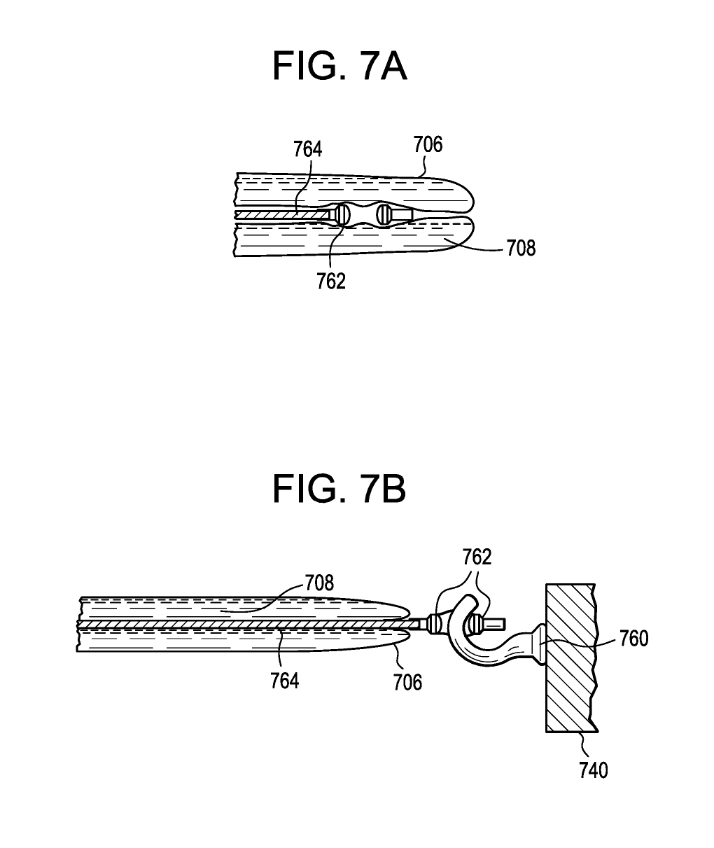

Referring now to FIGS. 6A-6E and 7A-7B, another alternative embodiment is one that subduces multiple tension bearing straps 764 or other supports beneath an object or a patient 636 as the internal tension element attached to the closed ends inside eversible membrane 706, with an additional means to attach these flexible straps 764 to an opposite side of a frame 640 that would lower around the patient 636 or an object, thus effectively constructing a stretcher beneath the patient 636 or object resting on a bed 638 or other surface. A structural frame 640 is positioned around the patient 636 and forms the outline of what effectively becomes a stretcher constructed beneath the patient 636 by inserting multiple support elements 630 beneath the patient 636 from one side of frame 640 and attaching them to the opposite side of the frame 640 once inserted. Before insertion, frame 640 is lowered around patient 636 as shown in FIG. 6A by lifts 644 to which the frame 640 is attached as part of base 642. Then support elements 630 can be inserted beneath the patient 636 as shown in FIGS, 6B-6C in accordance with the eversion technique discussed above. Frame 640 may include hooks 660 (as shown in FIG. 6E) or other suitable mechanism for securing the leading ends of the support elements 630 to the frame 640.

Referring to FIGS. 6C, 7A, and 7B, once support elements 630 are fully inserted beneath the patient 636, a metal grommet 762 or other suitable mechanism attached to the leading edge of tension bearing straps 764 can be secured to a counterpart hook 760 that is attached to frame 640. Such hooks or other suitable mechanisms are included for and correspond to each tension bearing strap 762. Once each strap is secured, tension applied to strap 762 by means not shown can be increased to a level sufficient in the aggregate of all straps to fully support the weight of the patient 636. Once all the straps are secured and tensioned, frame 640 can be elevated as shown in FIG. 6D. Alternatively, a plurality of eversible membranes that allow rigid supports to be inserted beneath a patient in a manner described above with respect to FIGS. 3A-3C could be attached to one side of a frame and the rigid supports, once inserted beneath the patient, are secured to an opposite side of the frame to form a stretcher beneath the patient.

Devices disclosed herein address the challenge of inserting support elements beneath an already lying down or reclining patient so that any number of other devices and techniques designed for safe patient handling can be simultaneously or subsequently applied.

Various materials are suitable for constructing essential components. Materials suitable for the flexible membrane include nylon “parachute cloth,” siliconized ripstop nylon fabric, Kevlar®, polyurethane impregnated Tyvek®, composites of multiple materials, and others. Suitable materials for the pressurizing fluid include air, carbon dioxide, nitrogen gas and non-toxic silicon oil, mixtures of fluids, and others. Suitable materials for the structural core of the appendages and other rigid and semi-rigid elements of the device include carbon fiber composites, high-pressure injection molded plastics, steel, aluminum, multiple-layered or nested materials, and others,

Fluid pressure may be actively maintained in the membrane using known techniques while actuating the retraction and extension control, which may comprise an internal spool, winch, piston, linear actuator or other known device for effecting linear motion attached directly, indirectly, or via the internal tension member to the inside of the distal end of the everting membrane, all within the pressurized environment of the canister.

Other useful embodiments in addition to safe patient handling, as briefly mentioned above, may include an add-on component for an existing piece of equipment designed for lifting, such as a forklift. In other embodiments, the eversible flexible appendage may be designed to mount on or integrate with a crane, hoist, or farm equipment such as a tractor for lifting livestock. In such an embodiment, the device may subduct hoist straps, and inflatable pad, or other supportive members beneath, e.g., an animal to be moved, and extension of the flexible appendage may be actuated using, e.g., compressed air from an air compressor powered by the power takeoff attachment of a farm tractor, although an actuator and/or compressor may be powered independent from the tractor in some embodiments.

In still other embodiments, the extensible soft robotic appendage can be used to grip objects for manipulation such as lifting, pulling, twisting, or other movements. In such an embodiment, the flexible membrane forming the body of the appendage may have relatively high surface friction properties as would a latex or other rubber coating. The radially inward motion of the membrane at the distal end that results when the eversible membrane forming the appendage is retracted by axially displacing the inner surface of the partially everted membrane in a proximal direction (e.g., the direction of the proximal end of the appendage when the appendage is fully everted) via actuation of an internal flexible or rigid member attached to or otherwise in communication with (e.g., using an internal magnet attached to the member and external magnet placed in the appropriate place on the appendage or otherwise) the inner surface causes a gripping action to be exerted on the object to be manipulated. Under the right conditions, a gripping or suction effect can be created at the distal end of the deformable membrane as it is drawn back into itself. This suction effect can be used to grip items. Both the position of the appendages and the retraction and/or extension of the distal end can be manipulated under dynamic control to result in a continuous range of possible net rates of displacement of the distal end of the appendage relative to the object being manipulated. Once the object is within the grip of the appendage, any other variety of desired movements can be executed. For example, a doorknob can be twisted, a screw can he turned, a component can be picked up and placed elsewhere or inserted into an assembly. By modulating the pressure in the deformable membrane and the inward tension acting on the closed end of the membrane in opposition to the outward pressure force acting on the frontal area of the membrane, the appendage can be made to partially or wholly envelop items. This may be used, for example, to grip highly radioactive items that could cause irreversible damage to robotic devices if they were to attempt to lift such items using a robotic arm. In such an embodiment, boric acid, argon gas, or other materials for shielding radiation and/or preventing nuclear criticality may be used to pressurize the appendage, and the membrane itself may comprise materials for shielding radiation and/or preventing criticality.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A support system comprising:
a plurality of casings each having a mouth and a spool, wherein each of the plurality of casings is suitable for containing a pressurized fluid;
a pressure device fluidly coupled to the plurality of casings, wherein the pressure device pressurizes a fluid; and
a plurality of membranes each having a closed end and an open end,
wherein the open end of each of the plurality of membranes is sealably attached to a corresponding respective mouth of one of the plurality of casings, and
wherein the closed end of each of the plurality of membranes is connected to a corresponding respective spool of one of the plurality of casings, and
wherein when the pressure device pressurizes the fluid, the closed end of each of the plurality of membranes is moved away from the corresponding one of the plurality of casings resulting in the plurality of membranes being everted between two unconnected surfaces; and
a frame with an opening, a proximal side and a distal side,
wherein the proximal side supports the plurality of casings, and wherein the plurality of membranes, after everting, can be coupled to the distal side of the frame,

2. The support system of claim 1 including a plurality of tethers, each tether connecting the closed end of one of the plurality of membranes to a corresponding respective spool of one of the plurality of casings.

3. The support system of claim 1 wherein the opening is of sufficient size such that the frame can fit around a recumbent patient.

4. The support system of claim 1 wherein the pressure device is an air compressor.

5. The support system of claim 1 wherein the pressure device includes CO₂ cartridges.

6. The support system of claim I wherein the pressure device includes a centrally supplied source for instrument air.

7. The support system of claim 1 including a plurality of tension straps, each attached to a corresponding one of the plurality of membranes such that the plurality of tensions straps are inserted between the two surfaces upon eversion of the plurality of membranes and can be attached to the distal side of the frame.

8. The support system of claim 1 including a plurality of flexible supports configured to be everted with a corresponding one of the plurality of membranes such that the plurality of supports are extended between the two surfaces upon eversion of the plurality of membranes.

9. The support system of claim 8 wherein at least one of the plurality of the flexible supports is an inflatable pad.

10. The support system of claim 1 wherein one of the surfaces is a bottom surface of a first object and another one of the surfaces is a top surface of a second object that the first object rests on.

11. A support system comprising:
a plurality of casings each having a mouth, wherein each of the plurality of casings is suitable for containing a pressurized fluid;
a pressure device fluidly coupled to the plurality of casings, wherein the pressure device pressurizes a fluid; and
a plurality of membranes each having a closed end and an open end,
wherein the open end of each of the plurality of membranes is sealably attached to a corresponding respective mouth of one of the plurality of casings, and
wherein the closed end of each of the plurality of membranes is attached to a corresponding rigid support member, and
wherein when the pressure device pressurizes the fluid, the closed end of each of the plurality of membranes is moved away from the corresponding casings resulting in the plurality of membranes being everted between two discontinuous surfaces and each rigid support member being inserted between the two surfaces; and
a frame with an opening, a proximal side and a distal side,
wherein the proximal side supports the plurality of casings, and wherein each rigid support member, after insertion between the two surfaces, can be coupled to the distal side of the frame.

12. A device for everting a membrane between two surfaces comprising:
a substantially rigid casing suitable for containing a pressurized fluid and having a mouth;
a pressure device fluidly coupled to the casing, wherein the pressure device pressurizes a fluid contained within the easing; and
a substantially tubular membrane having a closed end and an open end,
wherein the open end is sealably attached to the mouth of the casing, and
wherein when the pressure device pressurizes the fluid such that the closed end of the membrane is moved away from the casing resulting in the membrane being everted between two unconnected surfaces.

13. The device of claim 12 further including a flexible support configured to be everted with the membrane such that the flexible support is extended between the two surfaces upon eversion, wherein the membrane can be retracted while the flexible support remains between the two surfaces.

14. The device of claim 13 wherein the flexible support member is an inflatable pad.

15. The device of claim 12 including a tether connecting the closed end of the membrane to the casing, wherein the closed end of the membrane can be retracted by the tether toward the casing under tension against the pressurized fluid.

16. The device of claim 12 wherein one of the surfaces is a bottom surface of a first object and another one of the surfaces is a top surface of a second object that the first object rests on.

17. The device of claim 12 wherein the closed end is attached to a rigid support member and when the pressure device pressurizes the fluid such that the closed end of the membrane is moved away from the casing and resulting in the membrane being everted between the two unconnected surfaces, the rigid support member is inserted between the two unconnected surfaces.

18. The device of claim 12 wherein the pressure device is an air compressor.

19. The device of claim 12 wherein the pressure device includes CO₂ cartridges.

20. The device of claim 12 wherein the pressure device includes a centrally supplied source for instrument air.
